(19) United States
(12) Patent Application Publication
(10) Pub. No.: US 2024/0283209 A1
(43) Pub. Date: Aug. 22, 2024

(54) HIGH-BRIGHTNESS PICOSECOND LASER SYSTEM

(71) Applicant: LASER INSTITUTE OF SHANDONG ACADEMY OF SCIENCES, Jining, Shandong (CN)

(72) Inventors: Minzhe LIU, Jinan (CN); Kun ZHAO, Jinan (CN); Ruizhan ZHAI, Jinan (CN); Zhongqing JIA, Jinan (CN); Menglin LIU, Jinan (CN); Lisha WANG, Jinan (CN); Wei YAN, Jinan (CN); Xiaoqin YIN, Jinan (CN); Wei WANG, Jinan (CN); Huanxin LI, Jinan (CN); Mingshan ZHANG, Jinan (CN); Liyuan SUN, Jinan (CN); Zhenzhen ZHANG, Jinan (CN)

(73) Assignee: LASER INSTITUTE OF SHANDONG ACADEMY OF SCIENCES, Jining (CN)

(21) Appl. No.: 18/567,584

(22) PCT Filed: Feb. 24, 2023
(86) PCT No.: PCT/CN2023/078203

§ 371 Date: Dec. 6, 2023

(30) Foreign Application Priority Data
Mar. 14, 2022 (CN) 202210244487.2

(51) Int. Cl. H01S 3/094; H01S 3/10

(52) U.S. Cl. CPC H01S 3/094042; H01S 3/10061

(57) ABSTRACT

A high-brightness picosecond laser system, comprising a fully polarization-maintaining fiber picosecond seed laser (1), a fiber collimator (2), a space isolator (3), a polarization splitting prism (5), a first-stage solid traveling wave amplifier (6), a second-stage solid traveling wave amplifier (7), and a third-stage solid traveling wave amplifier (8) which are sequentially arranged in the laser transmission direction. The first-stage solid traveling wave amplifier (6) is located on the transmission light side of the polarization splitting prism (5), the second-stage solid traveling wave amplifier (7) is located on the reflected light side of the polarization splitting prism (5), and the fiber collimator (2) is connected to the fully polarization-maintaining fiber picosecond seed laser (1) by means of a tail fiber. The picosecond laser system is simple in structure, stable in performance and easy to maintain, can realize high-brightness 1064-mn laser output, and can realize green light output exceeding 50 W by arranging a frequency multiplication module (9) which is easy to integrate and disassemble.

The present disclosure claims priority to Chinese Patent Application No. 202210244487.2, filed with the China National Intellectual Property Administration on Mar. 14, 2022 and entitled “HIGH-BRIGHTNESS MASTER-OSCILLATOR POWER-AMPLIFIER PICOSECOND LASER SYSTEM”, disclosure of which is incorporated herein by reference in its entirety.

### FIELD OF THE INVENTION

The present disclosure relates to the field of ultrafast laser technologies, and in particular, to a high-brightness picosecond laser system.

### BACKGROUND OF THE INVENTION

In recent years, high-brightness picosecond lasers have been widely applied in fields such as microfabrication, precision ranging, medicine, and spectroscopy due to advantages of high spectral purity and high peak power. For outputting of high-brightness picosecond laser light, a fiber laser system may exhibit a very high gain and a low threshold, but with disadvantages of typically resulting in optical damages and significant nonlinear effects under high peak power. In contrast, a solid-state laser, typically including two manners of end pumping and side pumping, has advantages. Although an end pumping laser system may achieve a high gain under a short length of a gain medium, crystals that constitute the gain medium cannot withstand excessive high power, which affects power of final output laser light; and a side pumping laser system faces severe thermally-induced spherical aberration effects, which makes it difficult to control beam quality and affects brightness of final output laser light.

### SUMMARY OF THE INVENTION

A high-brightness picosecond laser system, including an all-polarization-maintaining optical fiber picosecond seed laser, an optical fiber collimator, a spatial isolator, a polarization beam splitter, a first-stage solid-state traveling-wave amplifier, a second-stage solid-state traveling-wave amplifier, and a third-stage solid-state traveling-wave amplifier that are sequentially disposed along an optical-path direction, where
the all-polarization-maintaining optical fiber picosecond seed laser is configured to emit picosecond seed laser light in a linear polarization state with a spectral width smaller than 0.3 nm;
the optical fiber collimator is connected to the all-polarization-maintaining optical fiber picosecond seed laser by a tail fiber, and is configured to collimate the picosecond seed laser light;
the spatial isolator is configured to isolate picosecond laser light returned from a subsequent optical path;
the polarization beam splitter is configured to transmit the picosecond seed laser light to the first-stage solid-state traveling-wave amplifier;
the first-stage solid-state traveling-wave amplifier is configured to amplify power of the picosecond seed laser light for a first time to form first picosecond laser light, and return the first picosecond laser light to the polarization beam splitter;
the polarization beam splitter is further configured to reflect the first picosecond laser light to the second-stage solid-state traveling-wave amplifier;
the second-stage solid-state traveling-wave amplifier is configured to amplify power of the first picosecond laser light for a second time to form second picosecond laser light; and
the third-stage solid-state traveling-wave amplifier is configured to amplify power of
the second picosecond laser light for a third time to form third picosecond laser light, so that the third picosecond laser light travels to a designated area.

In some implementations, the first-stage solid-state traveling-wave amplifier includes a Faraday rotator, a first half-wave plate, a first 45° dichroscope, a first laser crystal, and a first 0° total reflective mirror that are sequentially disposed along an optical-path direction, and a first laser diode and a first lens group that are sequentially disposed along a propagation direction of first pump light;
the Faraday rotator is configured to rotate a polarization state of the picosecond seed laser light by 45°, and the picosecond seed laser light travels to the first half-wave plate;
the first half-wave plate is a ½ wave plate, and is configured to adjust the polarization state of the picosecond seed laser light to a horizontal polarization state in cooperation with the Faraday rotator, so that the picosecond seed laser light travels to the first 45° dichroscope;
the first laser diode is configured to emit the first pump light to the first 45° dichroscope;
the first lens group is configured to collimate and focus the first pump light onto the first laser crystal;
the first 45° dichroscope is configured to reflect the picosecond seed laser light to the first laser crystal, and transmit the first pump light to the first laser crystal;
the first laser crystal is configured to amplify the power of the picosecond seed laser light passing through the first laser crystal, to obtain fourth picosecond laser light which is amplified, so that the fourth picosecond laser light travels to the first 0° total reflective mirror;
the first 0° total reflective mirror is configured to return the fourth picosecond laser light to the first laser crystal;
the first laser crystal is configured to further amplify power of the returned fourth picosecond laser light to obtain the first picosecond laser light, so that the first picosecond laser light travels to the first 45° dichroscope; and
the first 45° dichroscope is further configured to return the first picosecond laser light to the polarization beam splitter sequentially along the first half-wave plate and the Faraday rotator, where when the first picosecond laser light passes through the first half-wave plate and the Faraday rotator, a horizontal polarization state of the first picosecond laser light changes to a vertical polarization state.

In some implementations, the second-stage solid-state traveling-wave amplifier includes a second laser crystal, a second 45° dichroscope, a first lens, and a second half-wave plate that are sequentially disposed along a transmission direction for an optical path, and a second laser diode and a second lens group that are sequentially disposed along a propagation direction of second pump light;
the second laser crystal is configured to amplify the power of the first picosecond laser light that pass through the second laser crystal, so that the first picosecond laser light with amplified power travels to the second 45° dichroscope;
the second laser diode is configured to emit the second pump light to the second lens group;
the second lens group is configured to collimate and focus the second pump light;
the second 45° dichroscope is configured to reflect the first picosecond laser light with amplified power, and transmit the second pump light to form the second picosecond laser light to travel to the first lens;
the first lens is configured to collimate the second picosecond laser light, so that the second picosecond laser light travels to the second half-wave plate; and
the second half-wave plate is configured to adjust a vertical polarization state of the second picosecond laser light to a horizontal polarization state, so that the second picosecond laser light travels to the third-stage solid-state traveling-wave amplifier.

In some implementations, the third-stage solid-state traveling-wave amplifier includes a third 45° dichroscope, a first 56° polarizing plate, a first side-pumping module, a 90° polarimeter, a 4f system, a second side-pumping module, a ¼ wave plate, and a second 0° total reflective mirror that are sequentially disposed along a transmission direction for an optical path, and a second 56° polarizing plate for adjusting an optical path of reflected light from the first 56° polarizing plate;
the third 45° dichroscope is configured to reflect the second picosecond laser light in a horizontal polarization state to the first 56° polarizing plate;
the first 56° polarizing plate is configured to filter out laser light in a vertical polarization state from the second picosecond laser light, so that the second picosecond laser light travels to the first side-pumping module;
the first side-pumping module is configured to provide third pump light and a third laser crystal, where the third pump light provides energy for the second picosecond laser light by the third laser crystal, so that power of the second picosecond laser light is amplified to form fifth picosecond laser light which is traveling to the 90° polarimeter;
the 90° polarimeter and the 4f system are configured to compensate for thermally-induced birefrigent effects of the first side-pumping module and the second side-pumping module, respectively;
the second side-pumping module is configured to provide fourth pump light and a fourth laser crystal, where the fourth pump light provides energy for the fifth picosecond laser light by the fourth laser crystal, so that power of the fifth picosecond laser light is amplified to form sixth picosecond laser light which is traveling to the ¼ wave plate;
the ¼ wave plate is configured to adjust a polarization direction of the sixth picosecond laser light to travel to the second 0° total reflective mirror;
the second 0° total reflective mirror is configured to reflect the sixth picosecond laser light, so that the sixth picosecond laser light is returned to the second side-pumping module along the optical path;
the second side-pumping module and the first side-pumping module are further respectively configured to amplify power of the sixth picosecond laser light returned from the second 0° total reflective mirror to form the third picosecond laser light, so that the third picosecond laser light travels to the first 56° polarizing plate;
the first 56° polarizing plate is further configured to reflect the third picosecond laser light, so that the third picosecond laser light travels to the second 56° polarizing plate; and
the second 56° polarizing plate is configured to reflect the third picosecond laser light to a designated area.

In some implementations, downstream of an optical path of the third-stage solid-state traveling-wave amplifier further includes a frequency multiplication module, and the frequency multiplication module includes a second lens, a frequency multiplication crystal, a third lens, and a fourth 45° dichroscope that are sequentially disposed along an travel direction for an optical path, and a laser absorber disposed on an optical path of reflected light from the fourth 45° dichroscope;
the second lens is configured to focus the third picosecond laser light onto the frequency multiplication crystal;
the frequency multiplication crystal is configured to perform frequency multiplication on the third picosecond laser light, to form seventh picosecond laser light which is traveling to the third lens;
the third lens is configured to collimate the seventh picosecond laser light to travel to the fourth 45° dichroscope;
the fourth 45° dichroscope is configured to transmit the seventh picosecond laser light with frequency being multiplied to a designated area, and reflect the seventh picosecond laser light with frequency being not multiplied to the laser absorber; and
the laser absorber is configured to absorb the seventh picosecond laser light with frequency being not multiplied.

In some implementations, both of the first laser crystal and the second laser crystal are in cuboid structures, and are made of bonded Nd:YVO₄ crystals; and have input and output laser end faces in a square of 4 mm*4 mm and have a length of 35 mm.

In some implementations, the frequency multiplication crystal is a Type-I phase matched lithium triborate crystal, with non-critical phase matching angles satisfying that θ=90° and φ=0°; and the frequency multiplication crystal is in a cuboid structure with a square end face and a geometric parameter of 6 mm*6 mm*16 mm.

In some implementations, the high-brightness picosecond laser system further includes:
a 45° total reflective mirror, disposed at downstream of an optical path of the spatial isolator, and configured to reflect the collimated picosecond seed laser light to the polarization beam splitter.

In some implementations, the all-polarization-maintaining optical fiber picosecond seed laser is configured to generate picosecond pulse laser light with a wavelength of 1064 nm, a pulse width of less than 10 ps, maximum single pulse energy of greater than 100 nJ, and a tunable range of repetition rate of 1-20 MHz.

In some implementations, a range of a fill factor within the first-stage solid-state traveling-wave amplifier is 0.7-0.9; and a fill factor within the second-stage solid-state traveling-wave amplifier is 0.85.

### BRIEF DESCRIPTION OF THE DRAWINGS

To describe the technical solutions of the embodiments of the present disclosure or of the prior art to be more clear, the accompanying drawings for descriptions of the embodiments or the prior art are briefly introduced below.

FIG. 1 is a schematic diagram of the present disclosure according to some embodiments of the present disclosure;

FIG. 2 is a schematic diagram of a structure of a first-stage solid-state traveling-wave amplifier according to some embodiments of the present disclosure;

FIG. 3 is a schematic diagram of a structure of a second-stage solid-state traveling-wave amplifier according to some embodiments of the present disclosure;

FIG. 4 is a schematic diagram of a structure of a third-stage solid-state traveling-wave amplifier according to some embodiments of the present disclosure;

FIG. 5 is a schematic diagram of the present disclosure with a frequency multiplication module according to some embodiments of the present disclosure;

FIG. 6 is a schematic diagram of a structure of a frequency multiplication module according to some embodiments of the present disclosure;

FIG. 7 is a diagram of a test result of a wavelength of laser light of 1064 nm output in the present disclosure according to some embodiments of the present disclosure;

FIG. 8 is a diagram of a test result of output power and stability of laser light of 1064 nm output in the present disclosure according to some embodiments of the present disclosure;

FIG. 9 is a diagram of a test result of beam quality of laser light of 1064 nm output in the present disclosure according to some embodiments of the present disclosure;

FIG. 10 is a diagram of a test result of a pulse width of laser light of 1064 nm output in the present disclosure according to some embodiments of the present disclosure;

FIG. 11 is a diagram of a test result of a wavelength of laser light of 532 nm output in the present disclosure according to some embodiments of the present disclosure; and

FIG. 12 is a diagram of a test result of output power and stability of laser light of 532 nm output in the present disclosure according to some embodiments of the present disclosure.

In the figures: 1. All-polarization-maintaining optical fiber picosecond seed laser; 2. Optical fiber collimator; 3. Spatial isolator; 4. 45° total reflective mirror; 5. Polarization beam splitter; 6. First-stage solid-state traveling-wave amplifier; 61. Faraday rotator; 62. First half-wave plate; 63. First 45° dichroscope; 64. First laser crystal; 65. First 0° total reflective mirror; 66. First lens group; 67. First laser diode; 7. Second-stage solid-state traveling-wave amplifier; 71. Second laser crystal; 72. Second 45° dichroscope; 73. Second lens group; 74. Second laser diode; 75. First lens; 76. Second half-wave plate; 8. Third-stage solid-state traveling-wave amplifier; 801. Third laser crystal; 802. Fourth laser crystal; 81. Third 45° dichroscope; 82. First 56° polarizing plate; 83. First side-pumping module; 84. 90° polarimeter; 85. 4f system; 86. Second side-pumping module; 87. ¼ wave plate; 88. Second 0° total reflective mirror; 89. Second 56° polarizing plate; 9. Frequency multiplication module; 91. Second lens; 921. Frequency multiplication crystal; 922. Clamp; 923. Temperature control module; 93. Third lens; 94. Fourth 45° dichroscope; 95. Laser absorber.

### DETAILED DESCRIPTION OF THE EMBODIMENTS

High-brightness picosecond lasers are not only applied in fields such as microfabrication, precision ranging, medicine, and spectroscopy, but also serve as commonly used pump light sources in nonlinear optical frequency translation applications. Duration of interaction of a picosecond pulse with a material is short, so that effects of linear absorption of laser light, energy transfer and diffusion, and the like may be avoided. Thus, “cold processing” on the material is achieved.

An all-solid-state laser based on semiconductor pumping has a gain medium in a novel structure, so that thermal optical performance may be effectively improved. For example, a thin disk laser uses a gain medium with a thickness of several hundreds of microns for single-sided heat dissipation, where an excellent thermal management capability may ensure good beam quality while high-power laser output is obtained. However, a thin-disk laser crystal has a low single-pass gain and a complex multi-pass structure As a result, complexity of a system is greatly increased. In addition, a slab laser has advantages in technical complexity, but additional coupling and shaping technologies are required due to a special pump structure, which limits further development of the slab laser.

In contrast, an optical fiber picosecond laser is used as a seed source and a traveling wave solid-state amplifier is used as an amplification stage, so that not only a very high gain may be obtained, but beam quality may also be well controlled, which is an effective solution for obtaining high-power picosecond laser light. For the high-power picosecond laser light, a solid-state amplifier is typically used. Typically, there are two types of solid-state amplifiers, one of which is a regenerative amplifier with a diode pump-based solid-state gain medium, which may provide a high gain but has a complex structure and is expensive; another of which is a traveling wave amplifier, adopting a laser seed source directly amplifying low-power by using a multi-pass solid-state gain medium, having a simple structure and being easy for implementation. Traveling wave amplifiers are classified into end pumps and side pumps according to pumping manners.

The end pump has high pump power density, so that good mode matching between pump light and oscillating light may be implemented, and a high gain may be achieved under a short length of a gain medium. Representative crystals include Nd:YVO₄ and Nd:GdVO₄, having disadvantages that the crystal cannot withstand excessive high power and requires a multi-stage amplifier structure, which increases complexity of the system. A side-pumping module has advantages that it is not easy for the side-pumping module to explode during high-power pumping, and water cooling power of the module may be thousands of watts. Commonly used crystals include Nd:YAG and Yb:YAG. However, a main problem for this type of traveling wave amplifier is thermally-induced spherical aberration effects of the gain, that is, it is difficult to control the beam quality, which affects brightness of final output laser light.

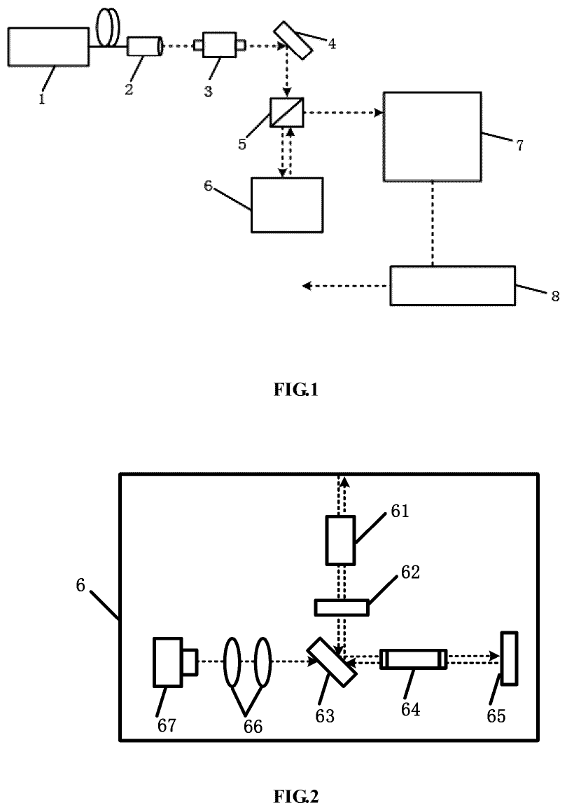

As shown in FIG. 1, the present disclosure provides a high-brightness picosecond laser system, including an all-polarization-maintaining optical fiber picosecond seed laser 1, an optical fiber collimator 2, a spatial isolator 3, a polarization beam splitter (PBS for short) 5, a first-stage solid-state traveling-wave amplifier 6, a second-stage solid-state traveling-wave amplifier 7, and a third-stage solid-state traveling-wave amplifier 8 that are sequentially disposed along an travel direction of laser light.

The all-polarization-maintaining optical fiber picosecond seed laser 1 is configured to emit picosecond seed laser light with a spectral width less than 0.3 nm and in a linear polarization state. In some examples, the all-polarization-maintaining optical fiber picosecond seed laser 1 is specifically configured to generate picosecond pulse laser light with a wavelength of 1064 nm, a spectral width of less than 0.3 nm, a pulse width of less than 10 ps, maximum single pulse energy of greater than 100 nJ, and a tunable range of repetition rate of 1-20 MHZ. The all-polarization-maintaining optical fiber picosecond seed laser 1 has advantages of a simple structure, stable performance, being easy for maintenance, and the like, and therefore is suitable for being applied in various external environments.

The optical fiber collimator 2 is connected to an output terminal of the all-polarization-maintaining optical fiber picosecond seed laser 1 by a tail fiber, and is configured to collimate the picosecond seed laser light. Horizontal polarization output or vertical polarization output of the picosecond pulse laser light is implemented through a rotation direction and a fixed position of the optical fiber collimator 2. A horizontal polarization state is used herein. In some examples, the optical fiber collimator 2 has a working distance of 1 m, and a laser light output from the optical fiber collimator 2 has a spot diameter set as D1.

The spatial isolator 3 is disposed at downstream of an optical path of the optical fiber collimator 2, and is configured to isolate laser light subsequently returned from the first-stage solid-state traveling-wave amplifier, the second-stage solid-state traveling-wave amplifier, and the third-stage solid-state traveling-wave amplifier. The spatial isolator 3 may prevent the returned picosecond laser light from damaging a device of the all-polarization-maintaining optical fiber picosecond seed laser. In some examples, the spatial isolator 3 may withstand power of 30 W.

The polarization beam splitter 5 is disposed at downstream of an optical path of the spatial isolator 3, and is configured to transmit picosecond seed laser light in a horizontal polarization state and reflect picosecond seed laser light in a vertical polarization state. In some examples, the polarization beam splitter 5 has an extinction ratio greater than 1000:1, and a damage threshold to coating greater than 1 J/cm² for laser light of 1064 nm with a pulse width of 10 ps.

The first-stage solid-state traveling-wave amplifier 6 is disposed at downstream of the polarization beam splitter 5, and is configured to amplify power of the picosecond seed laser light for a first time to form first picosecond laser light, and return the first picosecond laser light to the polarization beam splitter 5. In some examples, the first-stage solid-state traveling-wave amplifier 6 is located on a light transmission side of the polarization beam splitter 5.

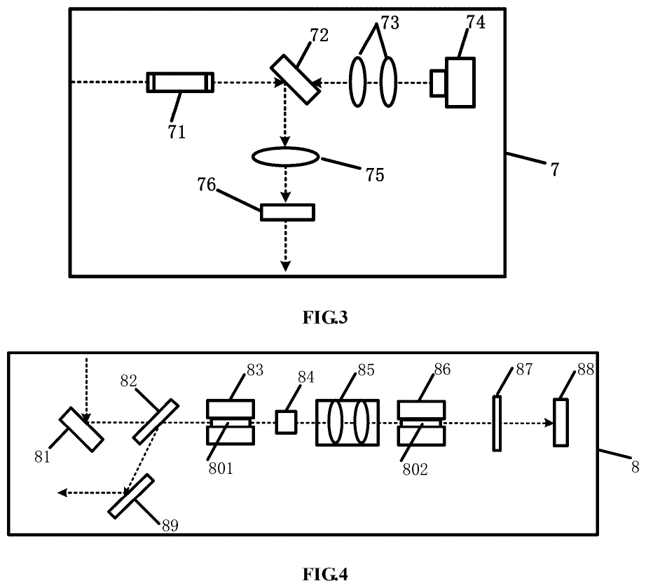

As shown in FIG. 2, in some embodiments, the first-stage solid-state traveling-wave amplifier 6 includes a Faraday rotator 61, a first half-wave plate 62, a first 45° dichroscope 63, a first laser crystal 64, and a first 0° total reflective mirror 65 that are sequentially disposed along a transmission direction for an optical path, and a first laser diode 67 and a first lens group 66 that are sequentially disposed along a propagation direction of first pump light. The foregoing devices are placed in space independently of each other, and have the respective geometric centers at the same levels, making it easy to adjust and improve efficiency.

The Faraday rotator 61 is disposed on a downstream optical path of the polarization beam splitter, and is configured to rotate a polarization state of the picosecond seed laser light by 45°. The Faraday rotator 61 corresponds to a wavelength of 1064 nm, and may withstand power greater than 30 W. After the picosecond seed laser light passes through the Faraday rotator 61, the polarization state of the picosecond seed laser light is rotated non-reciprocally by 45° along a polarization plane of the Faraday rotator 61, so that 45° rotation of the polarization state of the picosecond seed laser light is achieved.

The first half-wave plate 62 is a ½ wave plate, is disposed on a downstream optical path of the Faraday rotator 61, and is configured to convert the polarization state of the picosecond seed laser light to a horizontal polarization state in cooperation with the Faraday rotator 61. In some examples, the first half-wave plate 62 corresponds to a central wavelength of 1064 nm.

The Faraday rotator 61, the first half-wave plate 62, and the polarization beam splitter 5 may form a spatial isolator. The spatial isolator may isolate laser light returned from a subsequent optical path, thereby protecting the all-polarization-maintaining optical fiber picosecond seed laser 1.

The first 45° dichroscope 63 is disposed on a downstream optical path of the first half-wave plate 62, and is configured to reflect the picosecond seed laser light to the first laser crystal 64. In some examples, the first 45° dichroscope 63 has coating parameters with transmittance for pump light of 888 nm being greater than 98.5%, and reflectivity for laser light of 1064 nm being greater than 99%.

The first laser diode 67 is disposed on an upstream optical path of the first 45° dichroscope 63, and is configured to emit the first pump light to the first 45° dichroscope 63. In some examples, parameters of the first laser diode 67 are: a wavelength of the emitted pump light is 888 nm, or may be 878 nm or 880 nm; average output power is greater than 100 W; a fiber core diameter is 400 μm; and a numerical aperture NA is 0.22. For the first pump light emitted by the first laser diode 67, compared to common pump light with a wavelength of 808 nm, there is a lower quantum loss, thermal effects of a laser crystal may be greatly reduced, and it facilitates achieving better beam quality. When the first pump light travels to the first 45° dichroscope 63, the first 45° dichroscope 63 is further configured to transmit the first pump light to the first laser crystal 64, so that the first pump light and the picosecond seed laser light are coupled in the first laser crystal 64.

The first lens group 66 is disposed on a downstream optical path of the first laser diode 67, and is configured to collimate the first pump light and focus the first pump light onto the first laser crystal 64. In some examples, the first lens group 66 includes a first coated lens and a second coated lens. The first coated lens and the second coated lens are sequentially disposed on the downstream optical path of the first laser diode 67, and the first coated lens is adjacent to the first laser diode 67. In other words, the first coated lens is configured to collimate the first pump light emitted by the first laser diode 67; and the second coated lens is configured to focus the collimated first pump light onto the first laser crystal 64. In this case, a diameter of a spot focused onto the first laser crystal 64 is referred to as D2. A coating requirement for the two coated lenses is that transmittance for the first pump light is greater than 99.9%.

D1/D2 forms a fill factor. With D1 unchanged, the first coated lens in the first lens group 66 may have a focal length set to 30 mm, and the second coated lens may have a focal length of 45 mm. Through the first lens group 66, composed of the lenses with focal lengths of 30 mm and 45 mm, the first pump light may be expanded by 1.5 times, where a diameter of a focused spot is 600 μm. Through the first lens group 66, the first pump light is focused onto the first laser crystal 64 by a spot diameter as D2, with the fill factor of D1/D2 being 0.7-0.9. In this way, under the fill factor between 0.7 and 0.9, it is possible that there is relatively high extraction efficiency for the first picosecond laser light while good beam quality is ensured.

The first laser crystal 64 is disposed on a downstream optical path of the first 45° dichroscope 63, and is configured to provide a gain medium for power amplification of laser light therethrough. When the first pump light and the picosecond seed laser light that are mixed pass through the first laser crystal 64, power amplification may be performed on the picosecond seed laser light to obtain fourth picosecond laser light. Subsequently, the fourth picosecond laser light travels to the first 0° total reflective mirror 65. In some examples, the first laser crystal 64 is a bonded Nd:YVO₄ crystal, which may be a single-end bonded crystal (Nd:YVO₄-YVO₄) or a double-end bonded crystal (YVO₄-Nd:YVO₄-YVO₄), with a doping concentration of ions Nd³⁺ being 0.4%. The first laser crystal 64 has a length of 35 mm, with an input laser end face and an output laser end face each being in a square of 4 mm*4 mm, wherein a length of the Nd:YVO₄ crystal doped with Nd³⁺ ions is 33 mm, and a length of the YVO₄ crystal not doped with Nd³⁺ ions is 2 mm. Compared with a non-bonded crystal, by the first laser crystal 64, thermal effects of the crystal may be greatly reduced, thereby facilitating control of the beam quality. The first laser crystal 64 requires water cooling for heat dissipation, and a temperature range of water cooling is 18-25° C. The first laser crystal 64 may absorb the first pump light during operation and a thermal lens effect may be generated, equivalent to a thermal lens.

The first 0° total reflective mirror 65 is disposed on a downstream optical path of the first laser crystal 64, and is configured to return the fourth picosecond laser light to the first laser crystal 64. The first laser crystal 64 may further amplify power of the fourth picosecond laser light to obtain the first picosecond laser light. In some examples, reflectivity of the first 0° total reflective mirror 65 for the laser light of 1064 nm is greater than 99.9%. The first 0° total reflective mirror 65 is placed at a focal point of the thermal lens formed by the first laser crystal 64.

The first 45° dichroscope 63, the first laser crystal 64, and the first 0° total reflective mirror 65 form a dual-pass amplification structure to perform amplification, for two times, the picosecond seed laser light passing therethrough twice. The fourth picosecond laser light is obtained after the amplification is performed for the first time, and the first picosecond laser light is obtained after the amplification is performed for the second time, so that dual-pass amplification is implemented, thereby improving a gain and extraction efficiency. Meanwhile, the dual-pass amplification structure may also compensate for a positive spherical aberration generated at an amplification stage, thereby preventing deterioration of the beam quality. The first picosecond laser light on which dual-pass amplification is performed passes through the first half-wave plate 62 and the Faraday rotator 61 and becomes a first picosecond laser light in a vertical polarization state; and next, the first picosecond laser light is reflected from the polarization beam splitter 5 and enters the second-stage solid-state traveling-wave amplifier 7 for further power amplification.

After receiving the first picosecond laser light, the first 45° dichroscope 63 reflects the first picosecond laser light to the first half-wave plate 62. After sequentially passing through the first half-wave plate 62 and the Faraday rotator 61, the first picosecond laser light travels to the polarization beam splitter 5. During this process, when the first picosecond laser light passes through the first half-wave plate and the Faraday rotator, a horizontal polarization state of the first picosecond laser light changes to a vertical polarization state.

In this embodiment, power of picosecond laser light of 20 mW and 100 nJ may be amplified to be greater than 16 W by the first-stage solid-state traveling-wave amplifier 6 using the first laser diode 67 whose average power may reach 100 W.

As shown in FIG. 3, in some embodiments, the second-stage solid-state traveling-wave amplifier 7 is located on a light reflection side of the polarization beam splitter 5. The second-stage solid-state traveling-wave amplifier 7 includes a second laser crystal 71, a second 45° dichroscope 72, a first lens 75, and a second half-wave plate 76 that are sequentially disposed along a transmission direction for an optical path, and a second laser diode 73 and a second lens group 74 that are sequentially disposed along a propagation direction of second pump light.

The second laser crystal 71 is disposed at downstream of the polarization beam splitter 5, and is configured to amplify power of the first picosecond laser light reflected from the polarization beam splitter 5. In some examples, the second laser crystal 71 may be chosen to have a structure and a material which are same as the first laser crystal 64. The second laser diode 74 may output pump light with maximum average power greater than 120 W. For example, the second laser crystal 71 is in a cuboid structure, and is made of bonded Nd:YVO₄ crystals, with the doping concentration of the Nd³⁺ ions being 0.4%. The crystal has a length of 35 mm, with an input laser end face and an output laser end face each being in a square of 4 mm*4 mm, wherein a length of the Nd:YVO₄ crystal doped with Nd³⁺ ions is 33 mm, and a length of the YVO₄ crystal not doped with Nd³⁺ ions is 2 mm.

The second 45° dichroscope 72 is disposed on a downstream optical path of the second laser crystal 71, and is configured to reflect the first picosecond laser light passing through the second laser crystal 71. In some examples, the second 45° dichroscope 72 has coating parameters with transmittance for the second pump light being greater than 98.5% and reflectivity for laser light of 1064 nm being greater than 99%. The foregoing devices are placed in space independently of each other, and have the respective geometric centers at the same levels, making it easy to adjust and improve efficiency.

The second laser diode 74 is disposed on an upstream optical path of the second lens group 73, and is configured to emit the second pump light to the second lens group 73. In some examples, the second laser diode 74 may emit pump light with a wavelength of 888 nm, and may also emit pump light with a wavelength of 878 nm or 880 nm. Maximum average output power of the second laser diode 74 is greater than 120 W.

The second lens group 73 is disposed on an upstream optical path of the second 45° dichroscope 72, and is configured to collimate the second pump light emitted by the second laser diode 74, and focus the second pump light onto the second laser crystal 71. The second lens group 73 includes two coated lenses. The second lens group 73 has a function the same as that of the first lens group 66. Details are not repeated herein.

The second 45° dichroscope 72 is further configured to transmit the second pump light focused by the second lens group 73 to the second laser crystal 71. In addition, the first picosecond laser light is also reflected by the second 45° dichroscope 72. Therefore, the first picosecond laser light is coupled with the pump light at the second laser crystal 71 to generate second picosecond laser light.

The first lens 75 is disposed on a downstream optical path of the second 45° dichroscope 72. The first lens 75 is configured to collimate the second picosecond laser light so that the second picosecond laser light travels to the second half-wave plate 76.

The second half-wave plate 76 is disposed on a downstream optical path of the first lens 75. The second half-wave plate 76 is configured to adjust a polarization state of the second picosecond laser light to a horizontal polarization state, so that the second picosecond laser light travels to the third-stage solid-state traveling-wave amplifier 8.

In this embodiment, when the first picosecond laser light output from the first-stage solid-state traveling-wave amplifier 6, enters the second laser crystal 71 of the second-stage solid-state traveling-wave amplifier 7 after passing through the polarization beam splitter 5, the first picosecond laser light has a spot diameter as D3. Subsequently, power amplification is performed on the second picosecond laser light by the second laser crystal 71. After the second pump light output from the second laser diode 74 is collimated and focused by the second lens group 73, a focused spot has a diameter as D4. A fill factor (D3/D4) of the second-stage solid-state traveling-wave amplifier 7 is designed to be 0.85, thereby ensuring the beam quality and extraction efficiency of the laser light. In this way, by the second 45° dichroscope 72, the second picosecond laser light travels to the first lens 75. After being collimated by the first lens 75, the second picosecond laser light enters the third-stage solid-state traveling-wave amplifier 8. A laser with a power of 16 W output from the first-stage solid-state traveling-wave amplifier 6 may be amplified to over 50 W through the second-stage solid-state traveling-wave amplifier 7 using the second laser diode 74 with average power of 120 W.

As shown in FIG. 4, in some embodiments, the third-stage solid-state traveling-wave amplifier 8 includes a third 45° dichroscope 81, a first 56° polarizing plate 82, a first side-pumping module 83, a 90° polarimeter 84, a 4f system 85, a second side-pumping module 86, a ¼ wave plate 87, and a second 0° total reflective mirror 88 that are sequentially disposed along a transmission direction for an optical path, and a second 56° polarizing plate 89 that adjusts an optical path of reflected light from the first 56° polarizing plate 82.

The third 45° dichroscope 81 is disposed on a downstream optical path of the second-stage solid-state traveling-wave amplifier 7. The third 45° dichroscope 81 is configured to reflect the second picosecond laser light in a horizontal polarization state to the first 56° polarizing plate 82.

The first 56° polarizing plate 82 is disposed on a downstream optical path of the third 45° dichroscope 81. The first 56° polarizing plate 82 is configured to filter out laser light in a vertical polarization state from the second picosecond laser light, so that the second picosecond laser light in the horizontal polarization state travels to the first side-pumping module 83.

The first side-pumping module 83 is disposed on a downstream optical path of the first 56° polarizing plate 82. The first side-pumping module 83 is configured to provide third pump light and a third laser crystal 801. The third pump light provides energy for the second picosecond laser light by the third laser crystal 801, so that power of the second picosecond laser light is amplified to form fifth picosecond laser light which is traveling to the 90° polarimeter 84.

The second side-pumping module 86 is disposed on a downstream optical path of the first side-pumping module 83. The second side-pumping module 86 is configured to provide fourth pump light and a fourth laser crystal 802. The fourth pump light provides energy for the fifth picosecond laser light by the fourth laser crystal 802, so that power of the fifth picosecond laser light is amplified to form sixth picosecond laser light.

The first side-pumping module 83 and the second side-pumping module 86 both include a plurality of bar arrays, with a wavelength of 808 nm. The third laser crystal 801 and the fourth laser crystal 802 are correspondingly disposed in the first side-pumping module 83 and the second side-pumping module 86, respectively. The fourth laser crystal 802 and the third laser crystal 801 are both Nd:YAG crystals. The third laser crystal 801 is placed in the first side-pumping module 83, and the fourth laser crystal 802 is placed in the second side-pumping module 86, using water cooling for heat dissipation, with a temperature range of water cooling being 18-22° C.

The 90° polarimeter 84 and the 4f system 85 (the 4f system refers to two lenses with a focal length of f, a distance between the two lenses being 2f, with a subject distance being f and an image distance being also f) are sequentially disposed on the downstream optical path of the first side-pumping module 83, and are disposed between the first side-pumping module 83 and the second side-pumping module 86. The 90° polarimeter and the 4f system are configured to compensate for thermally-induced birefrigent effects of the third laser crystal 801 and the fourth laser crystal 802 in the first side-pumping module 83 and the second side-pumping module 86, thereby improving the beam quality.

The ¼ wave plate 87 is disposed on a downstream optical path of the second side-pumping module 86. The ¼ wave plate 87 is configured to adjust a polarization direction of the sixth picosecond laser light.

The second 0° total reflective mirror 88 is disposed on a downstream optical path of the ¼ wave plate 87. Moreover, the second 0° total reflective mirror 88 is disposed at a focal point of a thermal lens formed by the third laser crystal 801. The second 0° total reflective mirror 88 is configured to reflect the sixth picosecond laser light, so that the sixth picosecond laser light is returned along the original optical path. In some examples, the second 0° total reflective mirror 88 has coating parameters with transmittance for the fourth pump light being greater than 98.5% and reflectivity for laser light of 1064 nm being greater than 99%.

The second side-pumping module 86 and the first side-pumping module 83 are further respectively configured to amplify power of the sixth picosecond laser light returned from the second 0° total reflective mirror 88 to form the third picosecond laser light, so that the third picosecond laser light travels to the first 56° polarizing plate 82.

The first 56° polarizing plate 82 is further configured to reflect the third picosecond laser light, so that the third picosecond laser light travels to the second 56° polarizing plate 89.

The second 56° polarizing plate 82 is configured to reflect the third picosecond laser light to a designated area.

In this embodiment, the third-stage solid-state traveling-wave amplifier 8 receives the second picosecond laser light in horizontal polarized light, output from the second-stage solid-state traveling-wave amplifier 7, sequentially passing through the first side-pumping module 83 and the second side-pumping module 86 after sequentially passing through the third 45° dichroscope 81 and the first 56° polarizing plate 82. When passing through the first side-pumping module 83, the second picosecond laser light is amplified to form the fifth picosecond laser light. Subsequently, the fifth picosecond laser light enters the second side-pumping module 86. The sixth picosecond laser light is formed after the fifth picosecond laser light is amplified by the second side-pumping module 86. A polarization direction of the sixth picosecond laser light is changed by the ¼ wave plate 87. Subsequently, the sixth picosecond laser light amplified by the first side-pumping module 83 and the second side-pumping module 86 for a first time is further totally reflected by the second 0° total reflective mirror 88. Subsequently, the sixth picosecond laser light is returned along the original optical path, and is amplified for a second time in the second side-pumping module 86 and the first side-pumping module 83 to form the third picosecond laser light, so that dual-pass amplification of the picosecond laser light is achieved. During the dual-pass amplification process, through the 90° polarimeter and the 4f system that are disposed between optical paths of the first side-pumping module 83 and the second side-pumping module 86, compensation for the thermally-induced birefrigent effects of the pump modules may be achieved, thereby ensuring the beam quality. Upon dual-pass amplification of the third picosecond laser light by the first side-pumping module 83 and the second side-pumping module 86, a horizontal polarization state of the third picosecond laser light changes to a vertical polarization state due to presence of the ¼ wave plate. Finally, the third picosecond laser light is output from the second 56° polarizing plate 89. The laser with power of 50 W output from the second-stage solid-state traveling-wave amplifier 7 may be amplified to over 100 watts through the third-stage solid-state traveling-wave amplifier 8 using the first side-pumping module 83 and the second side-pumping module 86 each with average power of >200 W. Meanwhile, a beam quality factor is controlled to satisfy that M²<1.3.

In some embodiments, the high-brightness picosecond laser system further includes a 45° total reflective mirror 4. The 45° total reflective mirror 4 is disposed at downstream of an optical path of the spatial isolator 3, and is configured to reflect the collimated picosecond seed laser light to the polarization beam splitter 5. An overall length of the high-brightness picosecond laser system may be effectively reduced by using the 45° total reflective mirror 4, thereby improving practical applicability.

In view of the above, the first-stage solid-state traveling-wave amplifier, the second-stage solid-state traveling-wave amplifier, and the third-stage solid-state traveling-wave amplifier in the present disclosure are all traveling wave amplifiers, and by a combination of direct end pumping technologies and side pumping technologies, brightness of the output picosecond laser light of 1064 nm may be increased to over 5.7*10⁹ W·cm⁻². Sr through only three stages of amplifiers. In this way, not only an advantage of a high gain and high extraction efficiency under end pumping is maintained, but also maximum laser power may be improved due to a high damage threshold of a side pump. Moreover, by using of the first laser diode and the second laser diode in replace of a conventional multi-stage end-pumped traveling wave amplifier, a structure of laser is simplified, easy for integration. Moreover, operational stability of the laser is improved, and service life is prolonged.

In addition, the first laser crystal and the second laser crystal are respectively disposed on the downstream optical paths of the first laser diode and the second laser diode, to achieve compensation for the spherical aberration. By positive spherical aberrations brought by the first laser crystal and the second laser crystal, the first 0° total reflective mirror and the second 0° total reflective mirror are respectively placed at focal points of the first laser crystal and the second laser crystal. Meanwhile, the fill factor is adjusted, so that the beam quality is finally improved.

In General, in a laser system with a Nd:YVO₄ crystal solid-state amplifier as an amplification stage, a two-stage solid-state hybrid amplification method that uses an LD dual-end pumped solid-state laser amplifier and an LD side pumped solid-state laser amplifier may just implement output of laser light of 1064 nm with relatively lower power, where corresponding beam quality is 1.3, and brightness is typically lower than 1.47*10⁹ W·cm⁻²·Sr. In the present disclosure, a structure with a total of three stages of solid-state traveling-wave amplifiers, including the first-stage solid-state traveling-wave amplifier, the second-stage solid-state traveling-wave amplifier and the third-stage solid-state traveling-wave amplifier, may be used to implement output of laser light of 1064 nm with high average power. In other words, the laser system with an Nd:YVO₄ crystal solid-state amplifier as an amplification stage may only achieve a portion of the power in the present disclosure. For example, the laser system with the Nd:YVO₄ crystal solid-state amplifier as the amplification stage may maximally output laser light of 1064 nm with average power of 27.65 W, which is only 25.6% of the average power in the present disclosure. According to the present disclosure, laser light of 1064 nm with high average power of 103.24 W may be output, while the beam quality is controlled to be lower than 1.27, and brightness of the laser light reaches 5.74*10⁹ W·cm⁻²·Sr.

In addition, even if the output power is further increased through the two-stage solid-state hybrid structure including the LD dual-end pumped solid-state laser amplifier and the LD side pumped solid-state laser amplifier, the Nd:YVO₄ crystal may reach gain saturation, and the output power still cannot reach the power disclosed in the present disclosure. Even further increasing of the output power may result in that higher pump power is not absorbed and is converted into heat, causing damage to the crystal and a coating. Final output power of laser light may be significantly lower than the laser output of 27.65 W that has been achieved. In other words, the structure with three stages of solid-state traveling-wave amplifiers that is used in the present disclosure focuses on increasing the brightness of the picosecond laser light. When only a portion of the power in the present disclosure is reached, a solid-state traveling wave amplifier structure needs to be added to implement the brightness of the picosecond laser light that is to be achieved in the present disclosure.

In order to achieve an output of laser light of 1064 nm with high average power of 103.24 W in the present disclosure, parameters about a spectral width of the all-polarization-maintaining optical fiber picosecond seed laser need to be defined. In other words, the output of the laser light of 1064 nm with high average power of 103.24 W in the present disclosure may be achieved only when the spectral width of the all-polarization-maintaining optical fiber picosecond seed laser is less than 0.3, which helps to improve working efficiency of a backend solid-state amplifier.

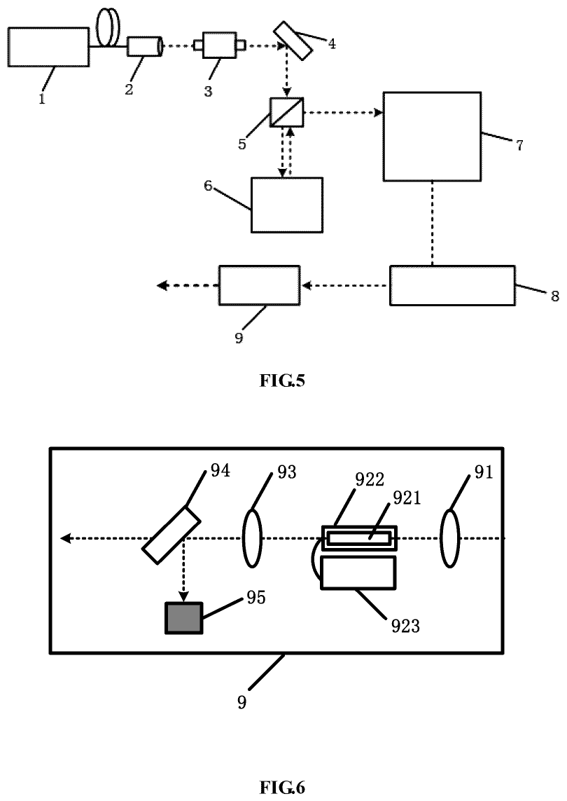

As shown in FIG. 5 and FIG. 6, in some embodiments, at downstream of an optical path of the third-stage solid-state traveling-wave amplifier 8, a frequency multiplication module 9 is further included. The frequency multiplication module 9 includes a second lens 91, a frequency multiplication crystal 921, a third lens 93, and a fourth 45° dichroscope 94 that are sequentially disposed along an travel direction for an optical path, and a laser absorber 95 disposed on an optical path of reflected light from the fourth 45° dichroscope 94.

In the present disclosure, the second lens 91 is disposed on a downstream optical path of the third-stage solid-state traveling-wave amplifier 8. The second lens 91 is configured to focus the third picosecond laser light to the frequency multiplication crystal 921.

The frequency multiplication crystal 921 is disposed on a downstream optical path of the second lens 91. The frequency multiplication crystal 921 is configured to perform frequency multiplication on the third picosecond laser light that is collimated for the first time, to form seventh picosecond laser light. In some examples, the frequency multiplication crystal 921 is wrapped with an indium foil with a thickness of 0.05 mm, and is placed in a clamp 922 to ensure close contact. A material of the clamp 922 may be red copper, and such a structure may improve frequency multiplication effects. The clamp 922 is connected to a temperature control module 923. The temperature control module 923 may be implemented by a thermoelectric cooler (TEC). The temperature control module 923 mainly changes temperature of the clamp 922 to accurately control temperature of the frequency multiplication crystal 921, thereby ensuring high frequency multiplication efficiency.

The frequency multiplication crystal 921 may be a Type-I phase matched lithium triborate crystal (a chemical formula is LiB₃O₅, LBO for short), with non-critical phase matching angles satisfying that θ=90° and φ=0°. The frequency multiplication crystal 921 may be in a cuboid structure with a square end face and a geometric parameter of 6 mm*6 mm*16 mm.

The third lens 93 is disposed on a downstream optical path of the frequency multiplication crystal 921. The third lens 93 is configured to collimate the seventh picosecond laser light on which frequency multiplication is performed.

The fourth 45° dichroscope 94 is disposed on a downstream optical path of the third lens 93. The fourth 45° dichroscope 94 is configured to transmit the collimated seventh picosecond laser light with frequency being multiplied, and reflect the collimated seventh picosecond laser light with frequency being not multiplied to the laser absorber. In some examples, the fourth 45° dichroscope 94 is configured to separate fundamental frequency light with a wavelength of 1064 nm (the seventh picosecond laser light with frequency being multiplied) from frequency-multiplied light with a wavelength of 532 nm (the seventh picosecond laser light with frequency being not multiplied). The fundamental frequency light of 1064 nm is completely absorbed by the laser absorber 95, so as to ensure safety of devices and personnel.

In this embodiment, the third picosecond laser light is received by the frequency multiplication module 9. The third picosecond laser light is focused onto the frequency multiplication crystal 921 through the second lens 91 to be frequency multiplied to form the seventh picosecond laser light. The seventh picosecond laser light is collimated through the third lens 93. The fourth 45° dichroscope 94 reflects the residual seventh picosecond laser light with a wavelength of 1064 nm during the frequency multiplication process to the laser absorber 95, to ensure output of seventh picosecond laser light with a single wavelength of 532 nm. The wavelength of 532 nm corresponds to green light. The frequency multiplication module 9 may output green light of >50 W by use of fundamental frequency light of 100 W and 1064 nm, with frequency multiplication efficiency greater than 50%. The frequency multiplication module 9 in the present disclosure may output green light of over 50 W on the basis of fundamental frequency light of over 100 watts, which may meet requirements on precision machining in various fields, such as cutting for solar cell materials, invisible QR code marking, cutting for flexible circuit boards, processing of organic light emitting diode (OLED) materials, and drilling of composite aerospace materials.

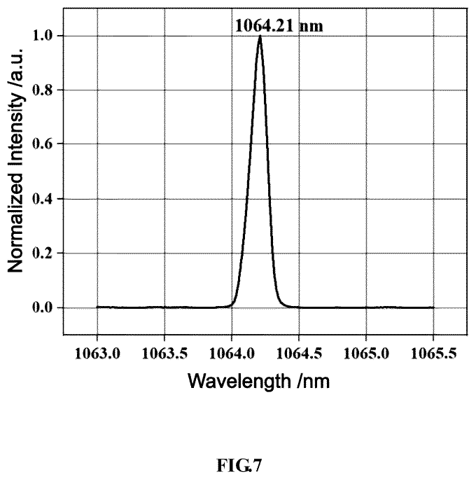

FIG. 7 to FIG. 10 respectively show test results of a wavelength, average power and stability, beam quality, and a pulse width of output laser light according to some embodiments of the present disclosure.

In experiments, the all-polarization-maintaining optical fiber picosecond seed laser 1 has output parameters that: average power is 20 mW, single pulse energy is 100 nJ, a repetition rate is 200 kHz, and beam quality M² is lower than 1.1.

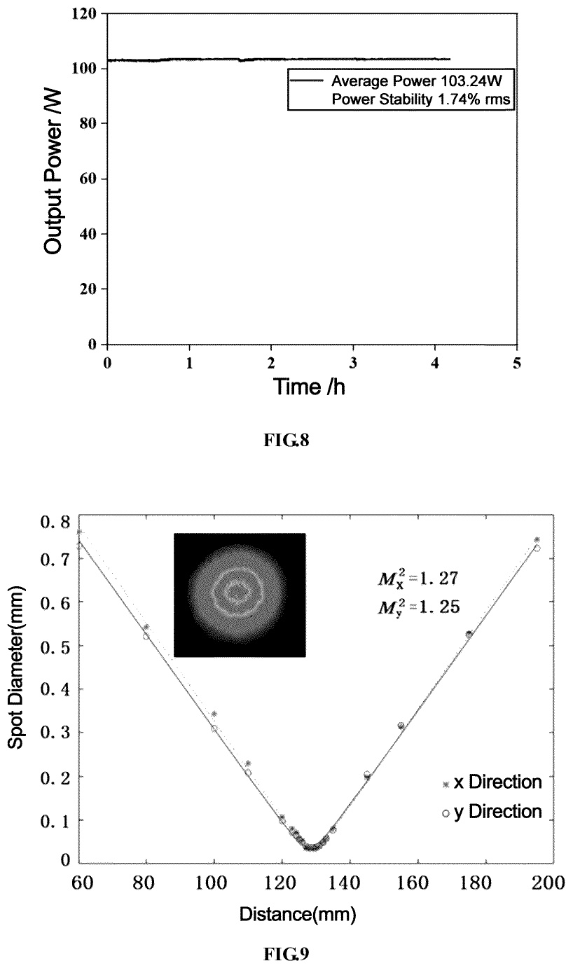

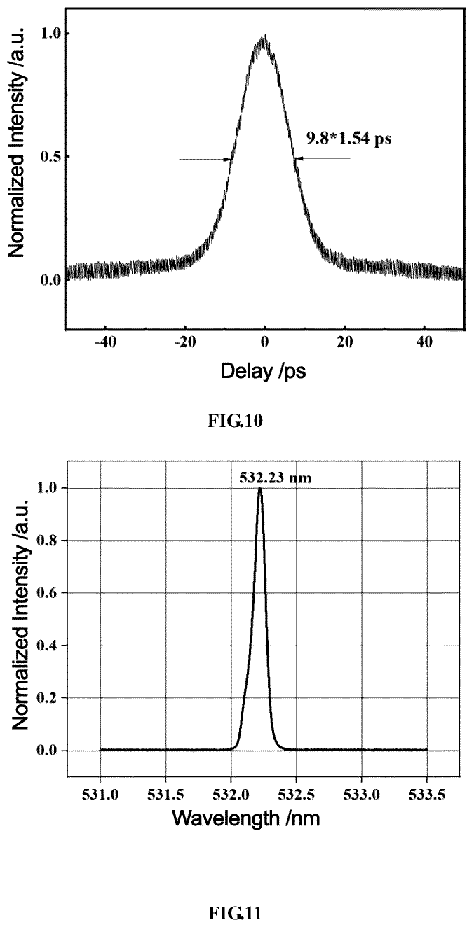

Results indicate that: (1) it is tested that a center wavelength of the laser light is 1064.21 nm by a YOKOGAWA (AQ6373B) spectrum analyzer (as shown in FIG. 7).
(2) by Thorlabs (with an S425C-L probe and a PM100D meter), it is tested that average power of laser light of 1064 nm is 103.24 W, and it is tested that power stability is 1.74% rms through continuously recording for 4 hours by a step of 0.3 s/single time (as shown in FIG. 8).
(3) It is tested that beam quality of laser light of 1064 nm is Mx2=1.27 and My2=1.25 by a Duma Optronics (BeamOn WSR UV-NIR) beam quality testing system (as shown in FIG. 9).
(4) it is obtained that a picosecond pulse width is 9.8 ps by FEMTOCHROME (FR-103XL) autocorrelation testing (as shown in FIG. 10).

In view of the above, brightness of the picosecond laser light of 1064 nm output from the high-brightness picosecond laser system in the present disclosure reaches 5.74*10⁹ W·cm⁻²·Sr.

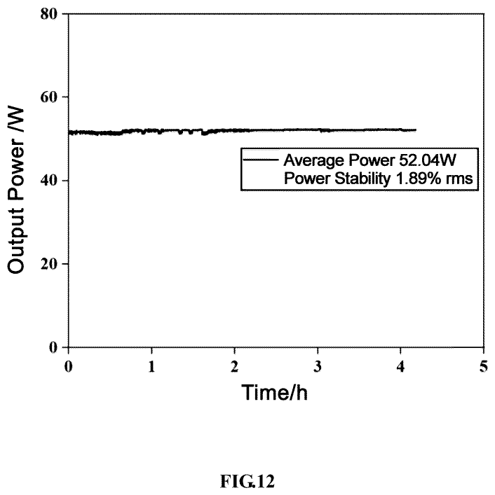

FIG. 11 and FIG. 12 respectively show test results of a wavelength, and of average power and stability of the seventh picosecond laser light output from the frequency multiplication module 9 according to some embodiments of the present disclosure.

Results indicate that: (1) it is tested that a center wavelength of the seventh picosecond laser light is 532.23 nm by the YOKOGAWA (AQ6373B) spectrum analyzer (as shown in FIG. 11).
(2) by using Thorlabs (with an S425C-L probe and a PM100D meter), it is tested that average power of the laser light of 532 nm is 52.04 W, and it is tested that power stability is 1.89% rms through continuously recording for 4 hours by a step of 0.3 s/single time (as shown in FIG. 12).

The foregoing embodiments of the present disclosure are described above, so that the present disclosure may be implemented or carried out by a person skilled in the art. Various modifications to these embodiments are obvious to a person skilled in the art. Moreover, general principles defined herein may be implemented in other embodiments without departing from the spirit or the scope of the present disclosure. Therefore, the present disclosure would not be limited to the embodiments shown herein, but should conform to a widest scope in accordance with the principles and novel features disclosed herein.

1. A high-brightness picosecond laser system, comprising an all-polarization-maintaining optical fiber picosecond seed laser, an optical fiber collimator, a spatial isolator, a polarization beam splitter, a first-stage solid-state traveling-wave amplifier, a second-stage solid-state traveling-wave amplifier, and a third-stage solid-state traveling-wave amplifier that are sequentially disposed along an optical-path direction, wherein
the all-polarization-maintaining optical fiber picosecond seed laser is configured to emit picosecond seed laser light with a spectral width less than 0.3 nm;
the optical fiber collimator is connected to the all-polarization-maintaining optical fiber picosecond seed laser by a tail fiber, and is configured to collimate the picosecond seed laser light;
the spatial isolator is configured to isolate picosecond laser light returned from a subsequent optical path;
the polarization beam splitter is configured to transmit the picosecond seed laser light to the first-stage solid-state traveling-wave amplifier;
the first-stage solid-state traveling-wave amplifier is configured to amplify power of the picosecond seed laser light for a first time to form first picosecond laser light, and return the first picosecond laser light to the polarization beam splitter;
the polarization beam splitter is further configured to reflect the first picosecond laser light to the second-stage solid-state traveling-wave amplifier;
the second-stage solid-state traveling-wave amplifier is configured to amplify power of the first picosecond laser light for a second time to form second picosecond laser light; and
the third-stage solid-state traveling-wave amplifier is configured to amplify power of the second picosecond laser light for a third time to form third picosecond laser light, so that the third picosecond laser light travels to a designated area.

2. The high-brightness picosecond laser system according to claim 1, wherein the first-stage solid-state traveling-wave amplifier comprises a Faraday rotator, a first half-wave plate, a first 45° dichroscope, a first laser crystal, and a first 0° total reflective mirror that are sequentially disposed along an optical-path direction, and a first laser diode and a first lens group that are sequentially disposed along a propagation direction of first pump light;
the Faraday rotator is configured to rotate a polarization state of the picosecond seed laser light by 45°, and the picosecond seed laser light travels to the first half-wave plate;
the first half-wave plate is a ½ wave plate, and is configured to adjust the picosecond seed laser light to be in a horizontal polarization state in cooperation with the Faraday rotator and travel to the first 45° dichroscope;
the first laser diode is configured to emit the first pump light to the first 45° dichroscope;
the first lens group is configured to focus the first pump light onto the first laser crystal;
the first 45° dichroscope is configured to reflect the picosecond seed laser light to the first laser crystal, and transmit the first pump light to the first laser crystal;
the first laser crystal is configured to amplify the power of the picosecond seed laser light passing through the first laser crystal to obtain fourth picosecond laser light which is amplified, so that the fourth picosecond laser light travels to the first 0° total reflective mirror;
the first 0° total reflective mirror is configured to return the fourth picosecond laser light to the first laser crystal;
the first laser crystal is configured to further amplify power of the returned fourth picosecond laser light to obtain the first picosecond laser light, so that the first picosecond laser light travels to the first 45° dichroscope; and
the first 45° dichroscope is further configured to return the first picosecond laser light to the polarization beam splitter sequentially along the first half-wave plate and the Faraday rotator, wherein when the first picosecond laser light passes through the first half-wave plate and the Faraday rotator, a horizontal polarization state of the first picosecond laser light changes to a vertical polarization state.

3. The high-brightness picosecond laser system according to claim 2, wherein the second-stage solid-state traveling-wave amplifier comprises a second laser crystal, a second 45° dichroscope, a first lens, and a second half-wave plate that are sequentially disposed along a transmission direction for an optical path, and a second laser diode and a second lens group that are sequentially disposed along a propagation direction of second pump light;
the second laser crystal is configured to amplify the power of the first picosecond laser light that pass through the second laser crystal, so that the first picosecond laser light with amplified power travels to the second 45° dichroscope;
the second laser diode is configured to emit the second pump light to the second lens group;
the second lens group is configured to collimate and focus the second pump light;
the second 45° dichroscope is configured to reflect the first picosecond laser light with amplified power, and transmit the second pump light to form the second picosecond laser light to travel to the first lens;
the first lens is configured to collimate the second picosecond laser light, so that the second picosecond laser light travels to the second half-wave plate; and
the second half-wave plate is configured to adjust a vertical polarization state of the second picosecond laser light to a horizontal polarization state, so that the second picosecond laser light travels to the third-stage solid-state traveling-wave amplifier.

4. The high-brightness picosecond laser system according to claim 1, wherein the third-stage solid-state traveling-wave amplifier comprises a third 45° dichroscope, a first 56° polarizing plate, a first side-pumping module, a 90° polarimeter, a 4f system, a second side-pumping module, a ¼ wave plate, and a second 0° total reflective mirror that are sequentially disposed along a transmission direction for an optical path, and a second 56° polarizing plate for adjusting an optical path of reflected light from the first 56° polarizing plate;
the third 45° dichroscope is configured to reflect the second picosecond laser light in a horizontal polarization state to the first 56° polarizing plate;
the first 56° polarizing plate is configured to filter out laser light in a vertical polarization state from the second picosecond laser light, so that the second picosecond laser light travels to the first side-pumping module;
the first side-pumping module is configured to provide third pump light and a third laser crystal, wherein the third pump light provides energy for the second picosecond laser light by the third laser crystal, so that power of the second picosecond laser light is amplified to form fifth picosecond laser light which is traveling to the 90° polarimeter;
the 90° polarimeter and the 4f system are configured to compensate for thermally-induced birefrigent effects of the first side-pumping module and the second side-pumping module, respectively;
the second side-pumping module is configured to provide fourth pump light and a fourth laser crystal, wherein the fourth pump light provides energy for the fifth picosecond laser light by the fourth laser crystal, so that power of the fifth picosecond laser light is amplified to form sixth picosecond laser light which is traveling to the ¼ wave plate;
the ¼ wave plate is configured to adjust a polarization direction of the sixth picosecond laser light to travel to the second 0° total reflective mirror;
the second 0° total reflective mirror is configured to reflect the sixth picosecond laser light, so that the sixth picosecond laser light is returned to the second side-pumping module along the optical path;
the second side-pumping module and the first side-pumping module are further respectively configured to amplify power of the sixth picosecond laser light returned from the second 0° total reflective mirror to form the third picosecond laser light, so that the third picosecond laser light travels to the first 56° polarizing plate;
the first 56° polarizing plate is further configured to reflect the third picosecond laser light, so that the third picosecond laser light travels to the second 56° polarizing plate; and
the second 56° polarizing plate is configured to reflect the third picosecond laser light to a designated area.

5. The high-brightness picosecond laser system according to claim 1, further comprises a frequency multiplication module at downstream of an optical path of the third-stage solid-state traveling-wave amplifier, and the frequency multiplication module comprises a second lens, a frequency multiplication crystal, a third lens, and a fourth 45° dichroscope that are sequentially disposed along an travel direction for an optical path, and a laser absorber disposed on an optical path of reflected light from the fourth 45° dichroscope;
the second lens is configured to focus the third picosecond laser light onto the frequency multiplication crystal;
the frequency multiplication crystal is configured to perform frequency multiplication on the third picosecond laser light, to form seventh picosecond laser light which is traveling to the third lens;
the third lens is configured to collimate the seventh picosecond laser light to travel to the fourth 45° dichroscope;
the fourth 45° dichroscope is configured to transmit the seventh picosecond laser light with frequency being multiplied to a designated area, and reflect the seventh picosecond laser light with frequency being not multiplied to the laser absorber; and
the laser absorber is configured to absorb the seventh picosecond laser light with frequency being not multiplied.

6. The high-brightness picosecond laser system according to claim 3, wherein both of the first laser crystal and the second laser crystal are in cuboid structures, and are made of bonded Nd:YVO₄ crystals; and have input and output laser end faces in a square of 4 mm*4 mm and have a length of 35 mm.

7. The high-brightness picosecond laser system according to claim 5, wherein the frequency multiplication crystal is a Type-I phase matched lithium triborate crystal, with non-critical phase matching angles satisfying that θ=90° and φ=0°; and the frequency multiplication crystal is in a cuboid structure with a square end face and a geometric parameter of 6 mm*6 mm*16 mm.

8. The high-brightness picosecond laser system according to claim 1, further comprising:
a 45° total reflective mirror, disposed at downstream of an optical path of the spatial isolator, and configured to reflect the collimated picosecond seed laser light to the polarization beam splitter.

9. The high-brightness picosecond laser system according to claim 8, wherein the all-polarization-maintaining optical fiber picosecond seed laser is configured to generate picosecond pulse laser light with a wavelength of 1064 nm, a pulse width of less than 10 ps, maximum single pulse energy of greater than 100 nJ, and a tunable range of repetition rate of 1-20 MHz.
